(19) United States
(12) Patent Application Publication
(10) Pub. No.: US 2007/0254997 A1
(43) Pub. Date: Nov. 1, 2007

(54) Thermoplastic Resin Composition for White Laser Marking on the Molding Surface

(75) Inventors: Hyoung Joo Chung, Ansan-si (KR); Youn Jae Jo, Hwaseong-si (KR); Jae Kyung Kim, Gunpo-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 11/776,615

(22) Filed: Jul. 12, 2007

Related U.S. Application Data
(63) Continuation-in-part of application No. PCT/KR2005/000956, filed on Mar. 31, 2005.

(30) Foreign Application Priority Data
Jan. 12, 2005 (KR) 10-2005-0002793

(51) Int. Cl. C08K 3/30

(52) U.S. Cl. 524/423; 524/495

(57) ABSTRACT

A thermoplastic resin composition for white laser marking includes (A) about 100 parts by weight of an acrylic thermoplastic resin; (B) about 0.001 to about 3 parts by weight of a black pigment having a particle size of about 10 to about 80 nm and an oil absorbency (dibutyl phthalate-DBP) of about 100 to about 350 cc/100 g; and (C) about 0.1 to about 10 parts by weight of a barium sulfate powder. The thermoplastic resin composition of the present invention may also optionally contain organic dyes, inorganic pigments or a mixture thereof.

### CROSS-REFERENCE TO RELATED APPLICATIONS

This non-provisional application is a continuation-in-part application of PCT Application No. PCT/KR2005/000956, filed Mar. 31, 2005, pending, which designates the U.S. and which is hereby incorporated by reference in its entirety, and also claims priority from Korean Patent Application No. 10-2005-0002793, filed Jan. 12, 2005, which is also hereby incorporated by reference in its entirety.

### FIELD OF THE INVENTION

The present invention relates to a thermoplastic resin composition useful for white laser marking applications.

### BACKGROUND OF THE INVENTION

A variety of known techniques such as pad printing, impregnation printing, laser marking, and the like are currently used to print on the surface of a molded resin article. Although methods using paint are frequently used, such processes can have high processing costs, environmental concerns resulting from the use and disposal of solvents, and low durability. In contrast, laser marking can be a cheaper and more efficient method than painting techniques and can ensure excellent durability of the printed materials. Laser marking is typically used to print letters on a keytop of a keyboard, a fax panel, and the like.

Generally, a black or dark-colored marking (hereinafter, ‘black-marking’) is effective on a molded article colored in light gray, cream or other colors having a high brightness or lightness. On the other hand, a white colored marking (hereinafter, ‘white-marking’) is typically not effective on a molded article colored in black or a dark-color.

The marked section tends to wear away over time as a result of repeated friction and pressure, which can deteriorate legibility. White-marking in particular can have a higher possibility of abrasion than black-marking, because white-marking protrudes from the surface of the plastic material. Secondly, legibility deterioration can result from stains or contamination from a users hand, since the surface of the white-marked section is rougher than that of tampo printing.

Korean Patent laid-open No. 1998-24437 discloses a resin composition for white marking consisting of an acrylic resin, styrenic resin and black colorant. This technique is advantageous over conventional tampo-printing because of its durability and legibility. However, the degree of whiteness and clearness of the marked letters can deteriorate.

### SUMMARY OF THE INVENTION

The present inventors have developed a thermoplastic resin composition for white laser marking including an acrylic thermoplastic resin, a specific black pigment and a barium sulfate powder. The composition of the invention can develop a white marking with a high degree of whiteness and clearness upon irradiation with a suitable laser. The composition of the invention can also exhibit excellent durability, which can minimize or prevent legibility deterioration caused by friction and pressure, as well as excellent appearance and impact resistance.

The thermoplastic resin composition for white laser marking according to the present invention can include (A) about 100 parts by weight of an acrylic thermoplastic resin; (B) about 0.001 to about 3 parts by weight of a black pigment having a particle size of about 10 to about 80 nm and an oil absorbency (dibutyl phthalate-DBP) of about 100 to about 350 cc/100 g; and (C) about 0.1 to about 10 parts by weight of a barium sulfate powder. The thermoplastic resin composition of the present invention may also optionally contain organic dye (D₁), pigment (D₂) or a mixture thereof. The present invention also provides molded articles formed of the thermoplastic resin composition as well as molded articles, which can be black or a dark color, irradiated with a laser to form markings on a surface thereof, which markings can be white.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

(A) Acrylic Thermoplastic Resin

The acrylic thermoplastic resin (A) can be used as a base resin in the present invention. The acrylic thermoplastic resin (A) includes a homopolymer or copolymer obtained from at least one monomer selected from the group consisting of acrylic acid, methacrylic acid, acrylic acid alkyl esters, methacrylic acid alkyl esters, and mixtures thereof. The role of the acrylic thermoplastic resin (A) of the present invention is to foam up in response to laser beam irradiation and develop a white marking on the surface of a molded article.

The acrylic acid alkyl esters and methacrylic acid alkyl esters can be prepared by the reaction of a monohydric alcohol containing 1 to 8 carbon atoms with an acrylic acid or a methacrylic acid respectively. Examples of acrylic acid alkyl esters and methacrylic acid alkyl esters useful in the invention can include without limitation acrylic acid methyl ester, acrylic acid ethyl ester, acrylic acid propyl ester, acrylic acid butyl ester, acrylic acid hexyl ester, acrylic acid 2-ethylhexyl ester, and corresponding methacrylic acid esters, including methacrylic acid methyl ester, and mixtures thereof.

The acrylic thermoplastic resin (A) may contain at least one comonomer other than the acrylic monomer. Such a comonomer needs only to be copolymerizable with the acrylic monomer, and can include vinyl ester monomers such as vinyl acetate and styrenic monomers. Examples of suitable comonomers useful in the invention can include without limitation styrene, α-methylstyrene, β-methylstyrene, C₁-C₃₀ alkyl styrene, halogenated styrene, maleic anhydride, acrylonitrile, methacrylonitrile, N-alkyl (C₁-C₃₀) maleimide, N-cycloalkyl (C₅-C₃₀) maleimide, N-aryl (C₆-C₃₀) maleimide, and the like, and mixtures thereof. In some embodiments, the comonomers can comprise styrene, α-methylstyrene, β-methylstyrene, o-methylstyrene, m-methylstyrene, p-methylstyrene, chlorostyrene, maleic anhydride, acrylonitrile, methacrylonitrile, N-methylmaleimide, N-phenylmaleimide and mixtures thereof.

In the present invention, the comonomer can be blended with the acrylic resin after (co)polymerizing the comonomer separately.

The acrylic thermoplastic resin (A) may contain a rubber component. The rubber component can include, for example, polybutadiene, butadiene-styrene copolymer, polyisoprene, butadiene-acrylonitrile copolymer, isobutylene-isoprene copolymer, ethylene-propylene rubber, acrylic rubber, urethane rubber, silicon rubber and the like, and mixtures thereof. The rubber component can be incorporated into the acrylic resin by copolymerization. Alternatively, the rubber component can be incorporated into the acrylic resin by blending after copolymerizing the rubber component with styrenic or acrylonitrile resin.

The composition ratio of acrylic monomers to the total monomers in the acrylic thermoplastic resin (A) can be about 1 to about 100% by weight, for example, about 10 to about 100% by weight. If the composition ratio of acrylic monomers is less than about 1% by weight, sufficient foaming may not occur in the laser irradiated areas, which can degrade the quality of the white marking.

When the acrylic resin is blended with other resin, the amount of the acrylic resin can be at least about 20% by weight. If the amount of the acrylic resin is less than about 20% by weight, the degrees of whiteness and clearness can deteriorate.

(B) Black Pigment

The black pigment (B) of the present invention includes a carbon compound having a network structure, so-called carbon black. Carbon black is generally produced from incomplete combustion of fuels, such as petroleum, acetylene gas, and the like. Depending on the method of production and the starting material, carbon black is classified as channel black, lamp black, acetylene black, furnace black, and so forth. The present invention can include any of the various known types of carbon black.

The carbon black used in the present invention can have an average particle size of about 10 to about 80 nm, for example about 10 to about 50 nm. Further, the carbon black of the present invention can have an oil absorbency (dibutyl phthalate-DBP) of about 100 to about 350 cc/100 g, for example about 150 to about 350 cc/100 g. If the oil absorbency (DBP) is less than about 100 cc/100 g, the foamability for the irradiated part is lowered, which can degrade the degree of whiteness. If the oil absorbency (DBP) is more than about 350 cc/100 g, the impact resistance and clearness of the mark can decrease.

The black pigment (B) may be used alone or in combination with other black dyes/pigments such as black iron oxide, composite oxides, single compounds, composite black prepared by mixing at least two kinds of dyes, and the like, and mixtures thereof.

The black pigment (B) of the present invention can be used in an amount of from about 0.001 to about 3 parts by weight, for example from about 0.01 to about 2 parts by weight, for example about 0.01 to about 0.5 parts by weight, per 100 parts by weight of acrylic thermoplastic resin (A). If the black pigment (B) is less than about 0.001 parts by weight, the foaming density is lowered so that the clearness of marking can degrade. If the black pigment (B) is more than about 3 parts by weight, the whiteness of the marked letter can deteriorate and can have a yellowish tint.

(C) Barium Sulfate Powder

The barium sulfate powder can be used as an inorganic auxiliary agent in the present invention. The barium sulfate powder can have an average particle size of about 0.1 to about 2 μm, for example about 0.1 to about 0.5 μm. The barium sulfate powder can satisfy the CIE L* value (Lightness) of at least about 98 for degree of whiteness, and can contain at least about 96% of pure barium sulfate. If the particle size of the barium sulfate exceeds about 2 μm, carbon black is shielded by barium sulfate, so that the foamability for the irradiated part is lowered, and the degree of whiteness can degrade. If the L* value (Lightness) of the barium sulfate powder is low, the degree of whiteness can also degrade.

The barium sulfate powder (C) of the present invention can be used in an amount of about 0.1 to about 10 parts by weight, for example about 0.5 to about 7 parts by weight, for example about 3 to about 6 parts by weight, per 100 parts by weight of acrylic thermoplastic resin (A). If the barium sulfate powder (C) is less than about 0.1 parts by weight, clearness of the marked letter can deteriorate, and if the barium sulfate powder (C) is more than about 10 parts by weight, the impact strength of the molded article can deteriorate.

(D) Colorants for Plastic Resin

The resin composition of the present invention may optionally contain other colorants including organic dye (D₁), pigment (D₂) and mixtures thereof.

The organic dye (D₁) can be selected from various types of solvent based dyes, such as but not limited to anthraquinone, perinone, methane, anthrapyridone, quinophthalone, coumarin and the like, and mixtures thereof.

Because the organic dye (D₁) colors the resin by being dissolved therein, it can affect the color of the marked letter. Accordingly, depending on the color of the dyes, the color of the marked letter can become a whitish tone of that color of the dyes. The more the amount of dye, the farther from pure white color the marked letter can become.

The organic dye (D₁) of the present invention can be used in an amount of about 0 to about 0.3 parts by weight, for example about 0 to about 0.1 parts by weight, per 100 parts by weight of acrylic thermoplastic resin (A). If the organic dye (D₁) is more than about 0.3 parts by weight, the marked letter cannot obtain pure white color.

The pigment (D₂) can be selected from single metal oxides, composite metal oxides, iron oxide, carbon black, ultramarine blue, phthalocyanine, perillene, azo lake pigment, and the like, and mixtures thereof.

The pigment (D₂) colors the resin by being dispersed in the form of the powder therein, so it does not greatly affect the color of the marked letter. The role of the pigments is to operate minutely on the surface color of molded resin

The pigment (D₂) of the present invention can be used in an amount of about 0 to about 2 parts by weight, for example about 0 to about 1 parts by weight, per 100 parts by weight of acrylic thermoplastic resin (A). If the amount of the pigment (D₂) exceeds about 2 parts by weight, the impact strength of the molding composition can decrease.

The present invention may be better understood by reference to the following examples that are intended for the purpose of illustration and are not to be construed as in any way limiting the scope of the present invention, which is defined in the claims appended hereto.

### EXAMPLES

The components used in Examples and Comparative Examples are as follows:

(A) Acrylic Resin

Methyl methacrylate-styrene copolymer with a weight average molecular weight of 100,000 and containing 40% by weight of methyl methacrylate is used.

(B) Black Pigment

The following carbon blacks produced by furnace process are used:

(B1) carbon black having a particle size of 18 nm and an oil absorbency (dibutyl phthalate-DBP) of 55 cc/100 g is used.

(B2) carbon black having a particle size of 55 nm and an oil absorbency (dibutyl phthalate-DBP) of 80 cc/100 g is used.

(B3) carbon black having a particle size of 30 nm and an oil absorbency (dibutyl phthalate-DBP) of 192 cc/100 g is used.

(C) Barium Sulfate Powder

Barium sulfate powder with an average particle diameter of 0.15 μm and containing 96.5% by weight of barium sulfate is used.

(C′) Calcium Carbonate Powder

Calcium carbonate with an average particle diameter of 5 μm produced by Chemipro kasei company of Japan (product name: Chemipro-A) is used.

(D₁) Organic Dye

Red dye of an anthraquinone type is used.

(D₂) Pigment

Blue pigment (ultramarine) is used.

### Examples 1 to 5 and Comparative Examples 1 to 4

The components as shown in Table 1 are mixed and the mixture is extruded through a twin screw extruder with L/D=32 and Φ=30 mm in pellets. The pellets are molded into color test specimens using a 3 oz injection molding machine at 210° C. The color test specimens are marked with a square-form in a size of 1×1 cm by irradiating laser beams with a laser marking machine.

The whiteness of the marking (the degree of whitening) is evaluated by measuring CIE L* value with a color spectrophotometer. The foamability is judged by inspecting a foamed cell of the marked section with a microscope of 40 magnifications (□: good, ∘: normal, □: bad). The durability is determined by rubbing the marked section with an eraser for 2000 times and inspecting the degree of damage in the marked section. The durability is also graded as follows: □: good, ∘: normal, □: bad. The test results are shown in Table 2.

TABLE 1

| | | Comparative Examples | | | | Examples | | | | |
|---|---|---|---|---|---|---|---|---|---|---|
| | | 1 | 2 | 3 | 4 | 1 | 2 | 3 | 4 | 5 |
| (A)acrylic resin | | 100 | 100 | 100 | 100 | 100 | 100 | 100 | 100 | 100 |
| (B) black | (B1) | 0.10 | — | — | — | — | — | — | — | — |
| pigment | (B2) | — | 0.10 | — | — | — | — | — | — | — |
| | (B3) | — | — | 0.01 | 0.01 | 0.01 | 0.10 | 0.10 | 0.02 | 0.046 |
| (C) barium sulfate | | 2.0 | 2.0 | — | — | 7.0 | 2.0 | 2.0 | 3.0 | 5.0 |
| (C′)calcium carbonate | | — | — | — | 2.0 | — | — | — | — | — |
| (D) colorants | (D₁) | 0.10 | 0.10 | — | — | — | 0.10 | 0.10 | 0.001 | 0.004 |
| | (D₂) | — | 0.60 | — | — | — | — | 0.60 | 0.3 | 0.4 |

TABLE 2

| | Comparative Examples | | | | Examples | | | | |
|---|---|---|---|---|---|---|---|---|---|
| | 1 | 2 | 3 | 4 | 1 | 2 | 3 | 4 | 5 |
| whiteness | 72.2 | 71.3 | 77.8 | 69.4 | 78.5 | 70.5 | 68.4 | 80.6 | 82 |
| foam- | □ | ∘ | □ | □ | □ | □ | □ | □ | □ |
| ability | | | | | | | | | |
| durability | ∘ | □ | ∘ | ∘ | □ | □ | □ | □ | □ |

Note:
□: good
∘: normal
□: bad

As shown above, the resin compositions of Examples 1-5 employing carbon black (B3) with an oil absorbency (dibutyl phthalate-DBP) of about 100 to about 350 cc/100 g show higher whiteness, foamability and durability than those of Comparative Examples 1-2 employing carbon blacks (B1), (B2) with an oil absorbency of less than about 100 cc/100 g, and those of Comparative Examples 3-4 not employing a barium sulfate powder.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition for white laser marking comprising:
(A) about 100 parts by weight of an acrylic thermoplastic resin;
(B) about 0.001 to about 3 parts by weight of a black pigment having a particle size of about 10 to about 80 nm and an oil absorbency (dibutyl phthalate-DBP) of about 100 to about 350 cc/100 g; and
(C) about 0.1 to about 10 parts by weight of a barium sulfate powder.

2. The thermoplastic resin composition for white laser marking as defined in claim 1, further comprising an organic dye (D₁).

3. The thermoplastic resin composition for white laser marking as defined in claim 1, further comprising a pigment (D₂).

4. The thermoplastic resin composition for white laser marking as defined in claim 1, wherein said acrylic thermoplastic resin (A) comprises a homopolymer or a copolymer comprising at least one acrylic monomer selected from the group consisting of acrylic acid, methacrylic acid, acrylic acid alkyl esters, methacrylic acid alkyl esters, and mixtures thereof.

5. The thermoplastic resin composition for white laser marking as defined in claim 1, wherein said acrylic thermoplastic resin (A) comprises a copolymer prepared by copolymerizing acrylic monomer with a comonomer selected from the group consisting of styrene, alkyl styrene, halogenated styrene, maleic anhydride, acrylonitrile, methacrylonitrile, N-alkylmaleimide, N-cycloalkylmaleimide, N-arylmaleimide, and mixtures thereof.

6. The thermoplastic resin composition for white laser marking as defined in claim 1, wherein said acrylic thermoplastic resin (A) comprises a copolymer prepared by copolymerizing acrylic monomer with a rubber component.

7. The thermoplastic resin composition for white laser marking as defined in claim 6, wherein said rubber component comprises a rubber selected from the group consisting of polybutadiene, butadiene-styrene copolymer, polyisoprene, butadiene-acrylonitrile copolymer, isobutylene-isoprene copolymer, ethylene-propylene rubber, acrylic rubber, urethane rubber, silicon rubber and mixtures thereof.

8. The thermoplastic resin composition for white laser marking as defined in claim 1, wherein the acrylic thermoplastic resin (A) comprises a ratio of acrylic monomers to total monomers of about 1 to about 100% by weight.

9. The thermoplastic resin composition for white laser marking as defined in claim 1, wherein said acrylic thermoplastic resin (A) comprises at least about 20% by weight of acrylic resin.

10. The thermoplastic resin composition for white laser marking as defined in claim 1, wherein said black pigment (B) comprises carbon black.

11. The thermoplastic resin composition for white laser marking as defined in claim 10, wherein said carbon black is selected from the group consisting of channel black, lamp black, acetylene black, furnace black, and mixtures thereof.

12. The thermoplastic resin composition for white laser marking as defined in claim 1, wherein said barium sulfate powder (C) has an average particle size of about 0.1 to a bout 2 μm, satisfies the CIE L* value of at least about 98 for degree of whiteness, and contains at least about 96% of pure barium sulfate.

13. The thermoplastic resin composition for white laser marking as defined in claim 2, wherein said organic dye (D₁) is selected from the group consisting of anthraquinone, perinone, methane, anthrapyridone, quinophthalone, coumarin, and mixtures thereof.

14. The thermoplastic resin composition for white laser marking as defined in claim 3, wherein said pigment (D₂) is selected from the group consisting of single metal oxides, composite metal oxides, iron oxide, carbon black, ultramarine blue, phthalocyanine, perillene, azo lake pigment, and mixtures thereof.

15. A molded article formed of a thermoplastic resin composition comprising:
(A) about 100 parts by weight of an acrylic thermoplastic resin;
(B) about 0.001 to about 3 parts by weight of a black pigment having a particle size of about 10 to about 80 nm and an oil absorbency (dibutyl phthalate-DBP) of about 100 to about 350 cc/100 g; and
(C) about 0.1 to about 10 parts by weight of a barium sulfate powder.

16. The molded article of claim 15, wherein said thermoplastic resin composition further comprises an organic dye (D₁).

17. The molded article of claim 15, wherein said thermoplastic resin composition further comprises a pigment (D₂).

18. A molded article irradiated with a laser and having markings on a surface thereof formed by said laser irradiation, the molded article formed of a thermoplastic resin composition comprising:
(A) about 100 parts by weight of an acrylic thermoplastic resin;
(B) about 0.001 to about 3 parts by weight of a black pigment having a particle size of about 10 to about 80 nm and an oil absorbency (dibutyl phthalate-DBP) of about 100 to about 350 cc/100 g; and
(C) about 0.1 to about 10 parts by weight of a barium sulfate powder.

19. The molded article of claim 18, wherein said molded article is black or a dark color and said markings on the surface of the molded article are white.
